(19) United States
(12) Patent Application Publication
(10) Pub. No.: US 2023/0078960 A1
(43) Pub. Date: Mar. 16, 2023

(54) INFORMATION PROCESSING APPARATUS, RECORDING MEDIUM, AND POSITIONING METHOD

(71) Applicant: CASIO COMPUTER CO., LTD., Tokyo (JP)

(72) Inventor: Nobuo IIZUKA, Tokyo (JP)

(21) Appl. No.: 17/943,055

(22) Filed: Sep. 12, 2022

(30) Foreign Application Priority Data
Sep. 16, 2021 (JP) 2021-151352

(51) Int. Cl. G06T 7/73; G06T 7/62; G06V 10/60

(52) U.S. Cl. CPC G06T 7/74; G06T 7/62; G06V 10/60; G06T 2207/30204; G06V 2201/07

(57) ABSTRACT

An information processing apparatus comprises a processing unit that acquires, from images captured by an imaging unit that is provided to a movable body and including markers that are disposed in a space, positions of the markers in an image coordinate system, acquire primary positioning information regarding the imaging unit in a world coordinate system, based on the positions of the markers in the image coordinate system and positions of the markers in the world coordinate system, and determines positioning information regarding the imaging unit based on the primary positioning information regarding the imaging unit in the world coordinate system and the positions of the markers in the world coordinate system.

### This application is based on and claims the benefit of priority from Japanese Patent Application No. 2021-151352, filed on 16 Sep. 2021, the content of which is incorporated herein by reference.

### BACKGROUND OF THE INVENTION

### Field of the Invention

The present invention relates to an information processing apparatus, a recording medium, and a positioning method for measuring a position.

### Related Art

There is a known technique for estimating a position of a movable body or the like by means of a captured image.

Japanese Unexamined Patent Application, Publication No. 2005-315746 discloses a technique relating to an own position identification method for a movable body that autonomously runs in an environment in which a plurality of markers are disposed at upper locations in an indoor space. According to the own position identification method of Japanese Unexamined Patent Application, Publication No. 2005-315746, the positions of the plurality of markers disposed on a ceiling or a similar place are registered in advance. The own position identification is performed in the following manner. Marker candidate points are extracted from an image of the ceiling captured from the movable body, and two-dimensional candidate point coordinates are calculated. A plurality of virtual points are arbitrarily set in a region where the movable body is able to travel. Two-dimensional coordinates of the markers in an image acquired when the movable body is present at the virtual point are derived from registered three-dimensional positions. The candidate point coordinates are compared with the two-dimensional coordinates. Two-dimensional coordinates that are most approximate to the candidate point coordinates are determined, and the virtual point at which the movable body is present and which corresponds to the determined two-dimensional coordinates is estimated as the own position.

### SUMMARY OF THE INVENTION

An aspect of the present invention is directed to an information processing apparatus comprising one or more processors. The one or more processors acquire, from an image captured by an imaging unit and including a marker disposed in a space, a position of the marker in an image coordinate system, acquire primary positioning information regarding the imaging unit in a world coordinate system, based on the position of the marker in the image coordinate system and a position of the marker in the world coordinate system, and determine the primary positioning information regarding the imaging unit, based on the primary information regarding the imaging unit in the world coordinate system and the position of the marker in the world coordinate system.

### BRIEF DESCRIPTION OF THE DRAWINGS

FIG. 1 is a schematic diagram illustrating an overall configuration of a positioning system including an information processing apparatus according to a first embodiment of the present invention;

FIG. 2 is a schematic diagram illustrating an image of a ceiling having thereon markers and auxiliary markers that are identifiable by the information processing apparatus according to the first embodiment;

FIG. 3 is a block diagram illustrating a hardware configuration of the information processing apparatus and a hardware configuration of an imaging unit according to the first embodiment;

FIG. 4 is a functional block diagram illustrating a functional configuration of the information processing apparatus according to the first embodiment;

FIG. 5 is a schematic diagram illustrating, as an example, the positions of markers and auxiliary markers according to the first embodiment;

FIG. 6 is a table showing, as an example, positions of the markers and auxiliary markers according to the first embodiment;

FIG. 7 is a flowchart illustrating a flow of a positioning process executable by the information processing apparatus according to the first embodiment;

FIG. 8 is a schematic diagram illustrating processing for extracting high-luminance regions from a captured image;

FIG. 9 is a schematic diagram illustrating processing for specifying, from extracted regions, auxiliary markers to be used for positioning;

FIG. 10 is a schematic diagram for describing processing for specifying markers from a captured image;

FIG. 11 is a table showing a list of in-image marker positions, in-image auxiliary marker positions, in-WC-system marker known positions, and in-WC-system auxiliary marker known positions according to the first embodiment;

FIG. 12 is a table showing a relationship between in-WC-system auxiliary marker known positions and calculative auxiliary marker positions according to the first embodiment;

FIG. 13A is a diagram illustrating a relationship between calculative auxiliary marker positions and in-image auxiliary marker positions according to the first embodiment in an image coordinate system;

FIG. 13B is a diagram illustrating a relationship between calculative auxiliary marker positions and in-image auxiliary marker positions according to the first embodiment in an image coordinate system;

FIG. 13C is a diagram illustrating a relationship between calculative auxiliary marker positions and in-image auxiliary marker positions according to the first embodiment in an image coordinate system;

FIG. 14 illustrates an example of a table in which in-image auxiliary marker positions are associated with in-WC-system auxiliary marker known positions, based on the in-image auxiliary marker positions and calculative auxiliary marker positions according to the first embodiment;

FIG. 15 is a schematic diagram illustrating an example in which auxiliary markers according to a second embodiment are quadrangle;

FIG. 16A is a schematic diagram illustrating an example in which vertexes of a polygonal auxiliary marker according to the second embodiment are assigned with auxiliary marker positions;

FIG. 16B is a schematic diagram illustrating an example in which vertexes of a polygonal auxiliary marker according to the second embodiment are assigned with auxiliary marker positions;

FIG. 17 is a flowchart illustrating a flow of process of acquiring in-image auxiliary marker positions in a case where the auxiliary markers according to the second embodiment have a polygonal shape;

FIG. 18A is a schematic diagram illustrating an example in which an auxiliary marker according to the second embodiment is of a size smaller than a predetermined size;

FIG. 18B is a schematic diagram illustrating an example in which a boundary of an auxiliary marker according to the embodiment is unclear;

FIG. 19 is an example of a table of in-WC-system auxiliary marker known positions in a case where an auxiliary marker according to the second embodiment has a quadrangular shape;

FIG. 20A is a conceptual diagram illustrating an example in which auxiliary markers in a captured image are identified by being associated with in-WC-system auxiliary marker known positions, and the identified in-WC-system auxiliary marker known positions are used as markers;

FIG. 20B is a conceptual diagram illustrating an example in which auxiliary markers according to an embodiment in a captured image are identified by being associated with in-WC-system auxiliary marker known positions, and the identified in-WC-system auxiliary marker known positions are used as markers;

FIG. 20C is a conceptual diagram illustrating an example in which auxiliary markers according to the embodiment in a captured image are identified by being associated with in-WC-system auxiliary marker known positions, and the identified in-WC-system auxiliary marker known positions are used as markers;

FIG. 20D is a conceptual diagram illustrating an example in which auxiliary markers according to the embodiment in a captured image are identified by being associated with in-WC-system auxiliary marker known positions, and the identified in-WC-system auxiliary marker known positions are used as markers; and

FIG. 20E is a conceptual diagram illustrating an example in which auxiliary markers according to the embodiment in a captured image are identified by being associated with in-WC-system auxiliary marker known positions, and the identified in-WC-system auxiliary marker known positions are used as markers.

### DETAILED DESCRIPTION OF THE INVENTION

Embodiments of the present invention will be described with reference to the drawings.

### (Positioning System 1)

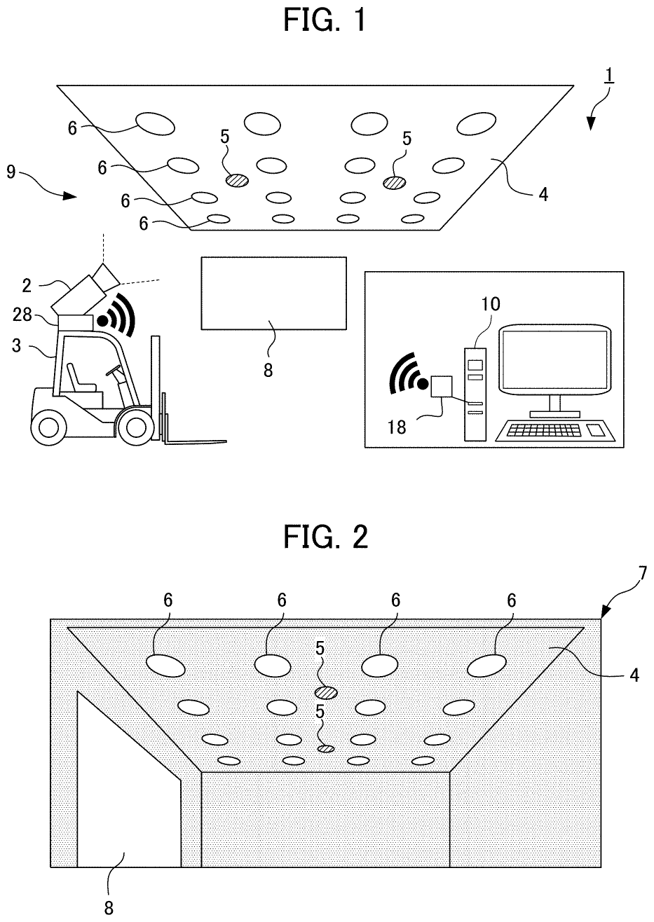

First, a positioning system 1 will be outlined with reference to FIG. 1. FIG. 1 is a schematic diagram illustrating an overall configuration of the positioning system 1 including an information processing apparatus 10 according to a first embodiment of the present invention. FIG. 2 is a schematic diagram illustrating an image 7 of a ceiling 4 having thereon markers 5 and auxiliary markers 6 that are identifiable by the information processing apparatus 10 according to the first embodiment.

As illustrated in FIG. 1, the positioning system 1 includes an imaging unit 2 mounted to not a building 9 including the ceiling but a movable body 3, markers 5 disposed inside the building 9 where the movable body 3 travels, and the information processing apparatus 10 for measuring a position of the movable body 3 based on the images 7 captured by the imaging unit 2.

The imaging unit 2 captures images 7 in a state where the movable body 3 has the imaging unit 2 mounted thereto. The imaging unit 2 of the present embodiment consecutively captures images of the ceiling 4 above the imaging unit 2 at a predetermined frame rate, thereby obtaining a plurality of temporally consecutive images 7 of the ceiling 4.

The imaging unit 2 is connected to a communication device 28 for communicating with the information processing apparatus 10. The images 7 captured by the imaging unit 2 or various pieces of information based on the images 7 are transmitted to the information processing apparatus 10 via the communication device 28. In this example, the movable body 3 having the imaging unit 2 mounted thereto is a work vehicle such as a forklift.

The marker 5 is an object including either one of a device and an indicator that enable acquisition of three-dimensional position information in a world coordinate system 70 in which the marker 5 is disposed from a database 19, by means of data transmitted by the marker 5 per se, or by way of image processing on an image of the marker 5 captured by the imaging unit 2.

The marker 5 of the present embodiment is, for example, a light emitting device capable of controlling light emitting modes thereof, such as a color of visible light and timing for emitting visible light. The marker 5 optically transmits identification information by, for example, changing the color of visible light or blinking visible light according to predetermined patterns. The marker 5 may emit near infrared light instead of visible light. In other words, it is only necessary for the marker 5 to emit light within a light wave band that can be captured by a camera.

In the present embodiment, a plurality of markers 5 are provided in order to specify the position and orientation of the imaging unit 2. In the example illustrated in FIG. 1, two markers 5 are provided at two locations on the ceiling 4. It should be noted that the markers 5 do not necessarily have to be disposed on the ceiling 4, and may be disposed in a space in the building 9 where the movable body 3 travels and the imaging unit 2 can capture images.

Each auxiliary marker 6 per se does not transmit data. In a case where the imaging unit 2 captures the auxiliary marker 6 in an image, three-dimensional position information in the world coordinate system 70 in which the auxiliary marker 6 is disposed cannot be acquired from the database 19 only by way of image processing. The auxiliary markers 6 are, for example, a plurality of light sources or lighting devices installed on the ceiling 4. In the present specification, the auxiliary markers 6 indicate a region that can be specified from the captured image 7 by way of image processing. The region is specified based on, for example, luminance, chromaticity, or the like.

The building 9 has a window 8. In a case where the window 8 is captured in the image 7, the window 8 may satisfy a luminance condition depending on a time zone. In this respect, image processing is executed such that control is performed so as not to process the region of the window 8 as the auxiliary marker 6. The auxiliary markers 6 of the present embodiment are not limited to auto-luminous objects. A reflective white material that reflects light, a green colored region existing on a brown plane, or the like may be specified as the auxiliary marker 6 from the image 7 by way of image processing.

The information processing apparatus 10 measures a position of the imaging unit 2 based on known positions of the markers 5 and the auxiliary markers 6, positions 51 of the markers 5 in the image 7 (hereinafter referred to as the in-image marker positions 51), and the positions 61 of the auxiliary markers 6 in the image 7 (hereinafter referred to as the in-image auxiliary marker positions 61). The known positions of the markers 5 and the auxiliary markers 6 may be specified from, for example, a design drawing in advance, or may be specified by another positioning device. In the present specification, the position of each marker 5 and the position of each auxiliary marker 6 are represented in terms of the three-dimensional world coordinate system 70.

The information processing apparatus 10 of the present embodiment is connected to a communication device 18 for communicating with the imaging unit 2. Establishing communication between the communication device 18 of the information processing apparatus 10 and the communication device 28 of the imaging unit 2 allows the information processing apparatus 10 to acquire the images 7 from the imaging unit 2.

### (Hardware Configuration)

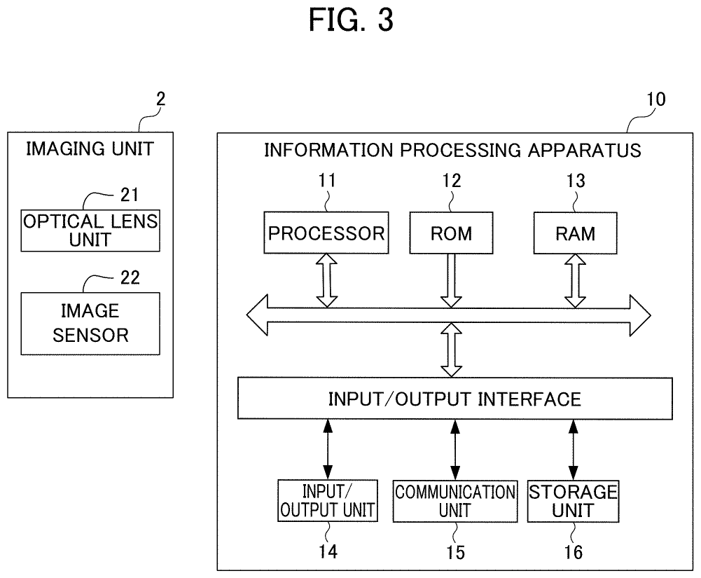

FIG. 3 is a block diagram illustrating a hardware configuration of the information processing apparatus 10 and a hardware configuration of the imaging unit 2 according to the first embodiment.

In the example illustrated in FIG. 3, the information processing apparatus 10 includes a processor 11, a read only memory (ROM) 12, a random access memory (RAM) 13, an input/output unit 14, a communication unit 15, and a storage unit 16.

The processor 11 performs various calculations and processing. The processor 11 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 11 is a combination of two or more of the foregoing components. Further, the processor 11 may be a combination of two or more of the foregoing components and a hardware accelerator or the like.

The processor 11, the ROM 12, and the RAM 13 are connected to one another via a bus. The processor 11 executes various types of processing in accordance with a program recorded in the ROM 12 or a program loaded to the RAM 13. A part or the entirety of the program may be incorporated in the circuitry of the processor 11.

The input/output unit 14 includes a keyboard, various buttons, a microphone, and the like, and inputs various kinds of information according to a user's instruction operation. The input/output unit 14 further includes a display, a speaker, and the like, and outputs images and sounds. The input/output unit 14 includes an information terminal with a touch panel. The communication unit 15 is a network interface for communicating with the imaging unit 2 and other devices via the communication device 18. The storage unit 16 is an area for storing various kinds of information such as the captured images 7 and known information.

Next, an example of the hardware configuration of the imaging unit 2 will be described. The imaging unit 2 includes an optical lens unit 21 and an image sensor 22.

The optical lens unit 21 includes a lens that condenses light in order to capture an image of a subject, such as a focus lens and a zoom lens. The focus lens is for forming a subject image on a light-receiving surface of the image sensor 22. The zoom lens is for freely changing the focal length within a certain range. The optical lens unit 21 is optionally provided with peripheral circuits for adjusting setting parameters such as focus, exposure, and white balance.

The image sensor 22 includes, for example, a photoelectric conversion element, an analog front end (AFE), etc. The photoelectric conversion element includes, for example, a complementary metal oxide semiconductor (CMOS) type photoelectric conversion element. An image of a subject is incident on the photoelectric conversion element from the optical lens unit 21. In response, the photoelectric conversion element photoelectrically converts (i.e., captures) the image of the subject, accumulates image signals for a certain period of time, and sequentially supplies the accumulated image signals to the AFE as analog signals. The AFE performs various signal processing such as analog/digital (A/D) conversion processing on the analog image signals. By way of the various signal processing, digital signals are generated, and the image 7 is output in the form of output signals from the imaging unit 2.

(Functional Configuration of Information Processing Apparatus)

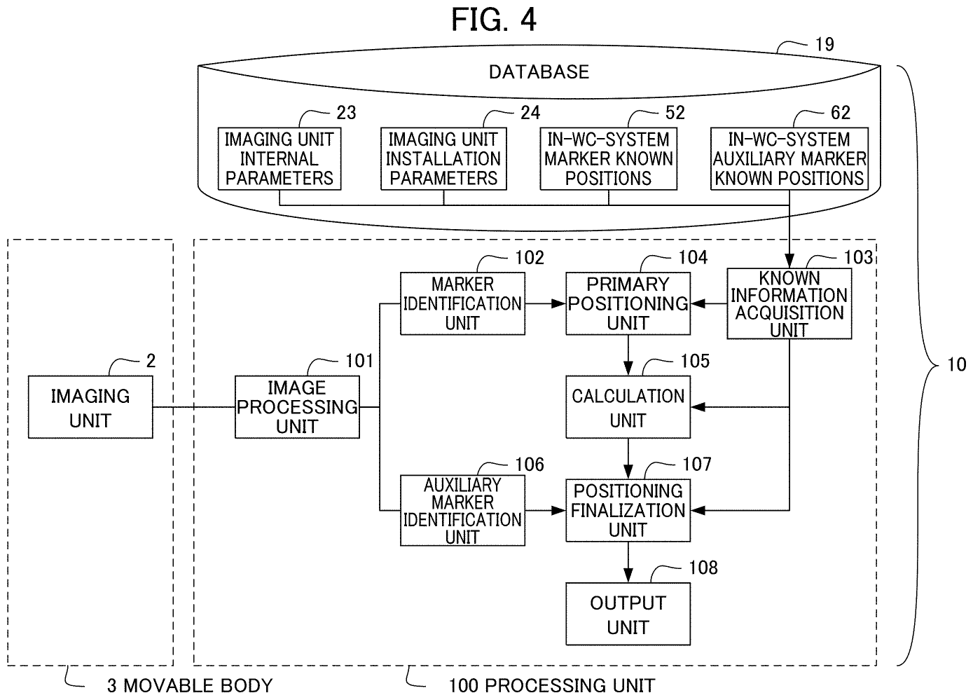

FIG. 4 is a functional block diagram illustrating a functional configuration of the information processing apparatus 10 according to the first embodiment. FIG. 4 illustrates the functional configuration, together with relationships in a flow of processing.

The information processing apparatus 10 performs various kinds of control by means of a processing unit 100 that is implemented by the processor 11 executing arithmetic processing based on predetermined programs.

The processing unit 100 of the present embodiment includes, on a function-to-function basis, an image processing unit 101, a marker identification unit 102, a known information acquisition unit 103, a primary positioning unit 104, a calculation unit 105, an auxiliary marker identification unit 106, a positioning finalization unit 107, and an output unit 108.

The image processing unit 101 acquires the image 7 and performs preprocessing such as distortion correction. The marker identification unit 102 is capable of acquiring the in-image marker positions 51 by executing processing for identifying the markers 5 from the image 7.

The known information acquisition unit 103 acquires, from the database 19, preset known information such as imaging unit internal parameters 23, imaging unit installation parameters 24, known marker positions 52 in the world coordinate system 70 (hereinafter referred to as the in-WC-system marker known positions 52), and known auxiliary marker positions 62 in the world coordinate system 70 (hereinafter referred to as the in-WC-system auxiliary marker known positions 62). The database 19 may be built in the storage unit 16 of the information processing apparatus 10, or may be built in a server outside the information processing apparatus 10.

The primary positioning unit 104 performs primarily positioning of the imaging unit 2 based on the in-image marker positions 51 acquired from the image 7 and the in-WC-system marker known positions 52 acquired from the database 19 to thereby acquire a primary position 23 of the imaging unit 2 in the world coordinate system 70 (hereinafter referred to as the in-WC-system imaging primary position). The in-WC-system imaging primary position includes the position where the imaging unit 2 is and the direction in which the imaging unit 2 is oriented.

The calculation unit 105 performs a projection calculation processing on an assumption that the in-WC-system auxiliary marker known positions 62 are projected onto an image 7 captured by the imaging unit 2, thereby calculating the projected positions. The auxiliary marker identification unit 106 performs identification processing by associating the positions 61 of the auxiliary markers 6 acquired from captured image 7 by way of image processing (hereinafter, referred to as the in-image auxiliary marker positions 61) with the in-WC-system auxiliary marker known positions 62. In the present embodiment, this associating processing is performed to calculate the position of the movable body 3 as a PnP problem including the in-image auxiliary marker positions 61 and the in-WC-system auxiliary marker known positions 62, in addition to the in-image marker positions 51 and the in-WC-system marker known positions 52. Thus, even in a case where a small number of markers 5 (e.g., two markers 5) are disposed, the position of the movable body 3 can be calculated with high accuracy by utilizing the auxiliary markers 6 such as existing lighting devices.

The positioning finalization unit 107 performs, based on, for example, the primary position of the imaging unit 2, the in-WC-system marker known positions 52, and the in-WC-system auxiliary marker known positions 62, processing for determining and acquiring the finalized position of the imaging unit 2 in the world coordinate system 70 (hereinafter referred to as the in-WC-system imaging unit determined position). The in-WC-system imaging unit determined position includes the position where the imaging unit 2 is and the direction in which the imaging unit 2 is oriented. The output unit 108 performs processing for outputting the results of the positioning.

In this example, the information processing apparatus 10 is installed at a location away from the imaging unit 2, but the present invention is not limited to this configuration. For example, the information processing apparatus 10 may be configured to be mounted to the movable body 3 or the imaging unit 2.

(Known Information)

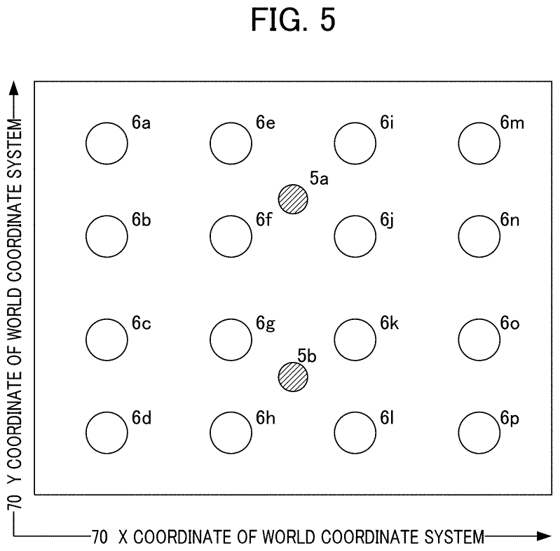

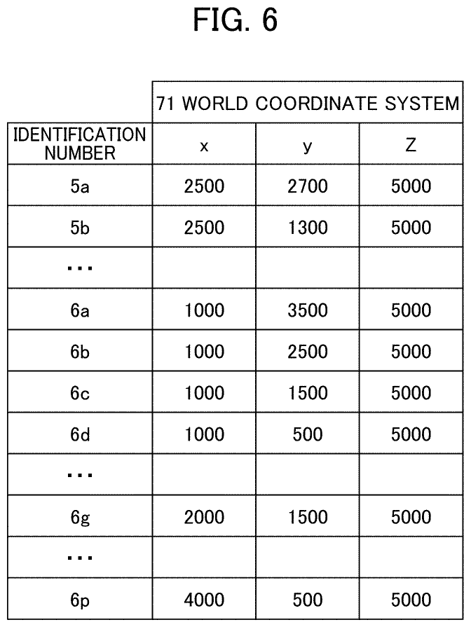

Next, examples of known information registered in advance in the database 19 will be described with reference to FIGS. 5 and 6.

FIG. 5 is a schematic planar diagram illustrating the markers 5 and the auxiliary markers 6 according to the first embodiment. In FIG. 5, the positional relationship between the markers 5 and the auxiliary markers 6 disposed on the ceiling 4 is illustrated in a plan view. In this example, the two markers 5 are assigned with identification numbers 5a and 5b, and are each processed as an individual marker. In the present embodiment, the sixteen auxiliary markers 6 are also assigned with identification numbers 6a to 6p, and are each processed as an individual auxiliary marker.

FIG. 6 is a table showing, as an example, the positions of the markers 5 and the positions of the auxiliary markers 6 according to the first embodiment in terms of the world coordinate system 70. As mentioned above, the positions of the markers 5 and the auxiliary markers 6 are specified in advance by means of a design drawing, positioning, or the like. FIG. 6 shows world coordinates as three-dimensional positions corresponding to the markers 5 denoted by the identification numbers 5a and 5b and the auxiliary markers 6 denoted by the identification numbers 6a to 6p. Here, for the sake of convenience, one of the corners of the ceiling 4 is defined as the origin, the x-axis and the y-axis are defined in a plan view, the vertical direction is defined as the z-axis, and the floor surface is defined as the origin for the Z-axis. In a state in which the database 19 contains, as the known information, the three-dimensional positions of the markers 5 and those of the auxiliary markers 6 registered therein in advance, a process of specifying the position of the imaging unit 2 is performed based on the images 7 of the ceiling 4 captured by the imaging unit 2.

(Positioning Process)

Next, a positioning process using the images 7 will be described. FIG. 7 is a flowchart illustrating a flow of the positioning process that is performed by the information processing apparatus 10 according to the first embodiment.

In response to a start of the positioning process, the processing unit 100 acquires the image 7 captured by the imaging unit 2, and performs distortion correction processing (Step S101). In the distortion correction processing, barrel aberration of the image captured by, for example, a wide-angle lens is corrected.

After Step S101, the processing unit 100 performs processing for specifying the positions of the auxiliary markers 6 (Step S102).

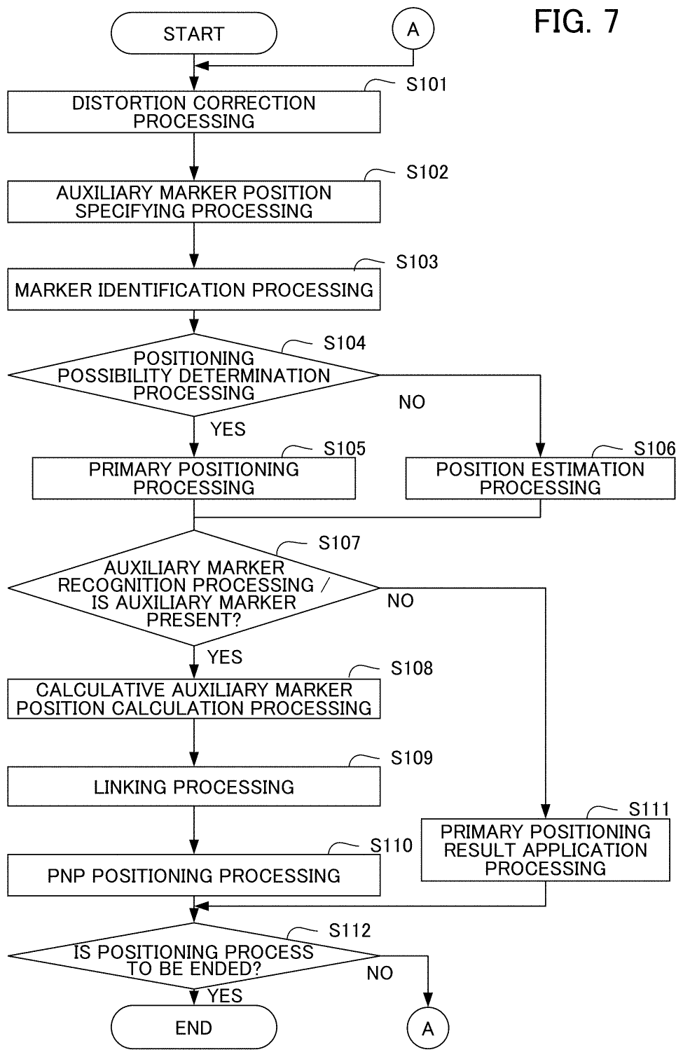

An example of the processing for specifying the positions of the auxiliary markers will be described with reference to FIGS. 8 and 9. FIG. 8 is a schematic diagram illustrating processing for extracting high-luminance regions from the captured image 7. As shown in FIG. 8, in order to specify the auxiliary markers 6 from the captured image 7, the image processing unit 101 of the processing unit 100 performs, as preprocessing, binarizing of the captured image 7 based on a predetermined threshold value, and thereby whitens only high-luminance regions and blackens the other regions. As a result, regions having a high luminance as in a saturated region are extracted. However, in this state, the location of the window 8 is also extracted as a high-luminance region in a case of a time period with daylight, such as daytime.

FIG. 9 is a schematic diagram illustrating processing for specifying, from the regions extracted with respect to FIG. 8, the auxiliary markers 6 to be used for positioning. As illustrated in FIG. 9, in order to exclude the region that originates from the window 8 and does not contribute to positioning, the image processing unit 101 performs filtering processing based on the actual shape, area, etc. of the extracted regions, and specifies only regions that highly provably correspond to the markers 5 and the auxiliary markers 6. Subsequently, a region center position is acquired for each of the plurality of auxiliary markers 6 by image processing, and the acquired region center positions are stored as the in-image auxiliary marker positions 61. The auxiliary marker identification unit 106 creates a list of the in-image auxiliary marker positions 61 of the auxiliary markers 6. Here, one of the following values in the world coordinate system 70 is adopted as the center position, for example: the center of gravity of the region recognized to be the auxiliary marker 6, the averages of the x, y, and z coordinates, and the intermediate value between the maximum and minimum coordinates. However, the center position is not limited to the foregoing values, and represents, as one position, the position of the auxiliary marker 6.

The in-image auxiliary marker positions 61 in the captured image 7 are specified with reference to two-dimensional coordinates set on the captured image 7. In the present specification, the two-dimensional coordinate system on the captured image 7 is referred to as the image coordinate system 71.

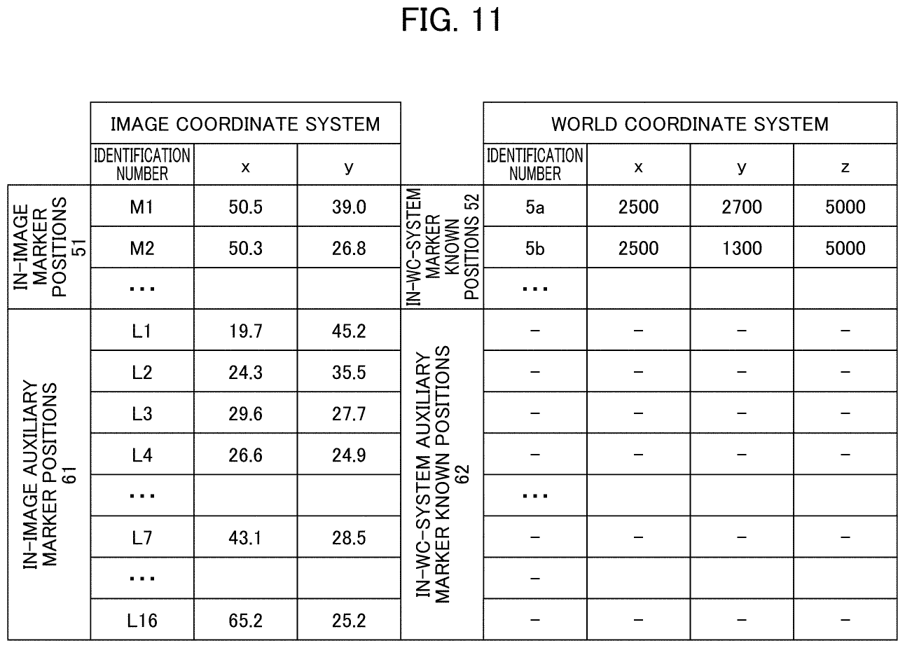

FIG. 11 shows, as an example, a list of in-image auxiliary marker positions 61. The auxiliary markers 6 having the in-image auxiliary marker positions 61 given thereto are assigned with primary identification numbers L1, L2, and so on. At this stage, the positions of the plurality of auxiliary markers 6 are merely specified from the captured image 7, and it is impossible to definitively determine which of the plurality of auxiliary markers 6 corresponds to which of the auxiliary markers 6a to 6p shown in FIG. 6. Thus, each of the plurality of auxiliary markers 6 cannot be uniquely identified. Therefore, as shown in FIG. 11, at this point in time, the auxiliary markers 6 are not yet linked to the in-WC-system auxiliary marker known positions 62.

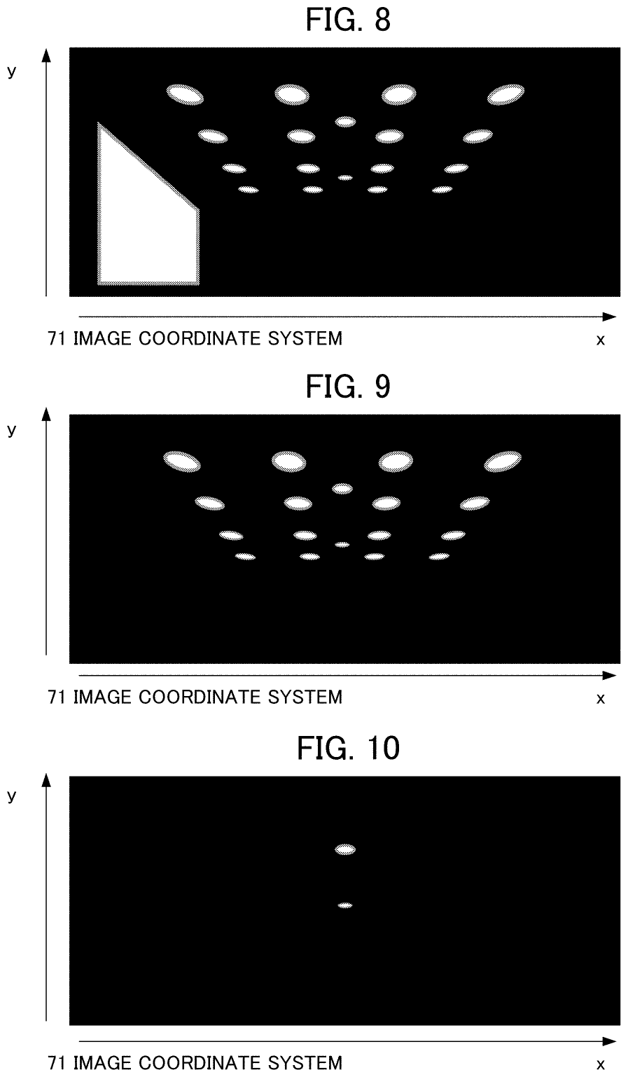

Next, the marker identification unit 102 performs marker identification processing (Step S103). FIG. 10 is a schematic diagram for describing processing for specifying the markers 5 from the captured image 7. As the marker identification processing, the marker identification unit 102 specifies the positions of the markers 5 from the captured image 7 by way of image processing.

FIG. 11 shows, as an example, a list of in-image marker positions 51 and in-WC-system marker known positions 52. The markers 5 having the in-image marker positions 51 given thereto are assigned with primary identification numbers Ml, M2, and so on. Since the markers 5 have been identified, the in-image marker positions 51 denoted by Ml and M2 are linked to the markers 5a and 5b shown in FIG. 5.

An example of the marker identification processing will be described. The marker identification unit 102 determines a light emission pattern based on captured consecutive images 7, and compares the light emission pattern with a preset light emission pattern to specify the positions of the markers 5 in the captured images 7.

Next, the primary positioning unit 104 performs positioning possibility determination processing (Step S104). As the positioning possibility determination processing, for example, the primary positioning unit 104 determines whether two or more markers 5 are present in the captured image 7 and positioning can be performed based on the markers 5.

When it is determined that positioning can be performed based on the markers 5 (Step S104: YES), the primary positioning unit 104 performs primary positioning processing

(Step S105).

An example of the primary positioning processing will be now described. As described above, since the markers 5a and 5b can be individually identified from the captured image 7, the primary positioning unit 104 acquires the in-WC-system marker known positions 52 of the markers 5a and 5b based on the correspondence shown in FIG. 11.

As the primary positioning processing, for example, the primary positioning unit 104 performs primary positioning of the imaging unit 2 by way of the PnP positioning processing, based on the in-image marker positions 51 and the in-WC-system marker known positions 52.

As is conventionally known, when positions of a group of points and positions in a captured image 7 are given, the position, the posture, and the like of the imaging unit 2 are determined by way of the PnP positioning processing. In a case where positioning is performed based on six points, the position and the imaging direction (an in-plane azimuth, an elevation angle) of the imaging unit 2 can be determined. Even in a case where the number of points is less than six, for example, when the imaging unit 2 is on a plane parallel to the ceiling 4 on which the markers 5 and the auxiliary markers 6 are disposed, the position and elevation angle of the imaging unit 2 can be determined by way of positioning based on only two points, even though the resulting accuracy is not high.

Since the movable body 3 moves on the floor surface parallel to the ceiling 4, the primary positioning unit 104 can determine, by way of a P2P method, the in-WC-system imaging primary position that includes the primary position and elevation angle of the imaging unit 2. The primary positioning unit 104 determines the in-WC-system imaging primary position, which is the primary position of the imaging unit 2, by way of the P2P method and using the in-image marker positions 51 denoted by identification numbers Ml and M2 and the in-WC-system marker known positions 52 denoted by identification numbers 5a and 5b shown in FIG. 11.

In a case where the positioning cannot be performed based on the markers 5 (Step S104: NO), the primary positioning unit 104 performs position estimation processing (Step S106). As the position estimation processing, for example, the primary positioning unit 104 estimates the position of the imaging unit 2 based on a previously-acquired in-WC-system imaging unit determined position and a movement vector history, and defines the estimated position as a primary positioning result.

Next, the calculation unit 105 performs auxiliary marker recognition processing (Step S107). As the auxiliary marker recognition processing, for example, the calculation unit 105 determines whether or not an auxiliary marker 6 is present in the captured image 7.

When there is no auxiliary marker 6 in the captured image 7 (Step S107: NO), the primary positioning unit 104 performs primary positioning result application processing (Step S111). As the primary positioning result application processing, for example, the primary positioning unit 104 applies the primary positioning result as a determined positioning result.

When the auxiliary markers 6 are present in the captured image 7 (Step S107: YES), the calculation unit 105 performs position calculation processing for the auxiliary markers 6 (hereinafter, referred to as the auxiliary marker position calculation processing) (Step S108). The auxiliary marker position calculation processing is performed in the following manner, for example. On an assumption that the in-WC-system auxiliary marker known positions 62 are captured in an image 7 from the in-WC-system imaging primary position determined based on the primary positioning result, the calculating unit 105 calculates positions where the position of the in-WC-system auxiliary marker known positions 62 would appear on the captured image 7, in other words, positions 63 at which the in-WC-system auxiliary marker known positions 62 would be projected (hereinafter referred to as the calculative auxiliary marker positions 63).

This calculation is well-known processing for inversely calculating a position where an arbitrarily-designated three-dimensional point is drawn on an image, from the position and posture of the imaging unit 2. The calculation itself is a simple matrix calculation. Therefore, the projection will be implemented in an infinite view field, and the back side of the in-WC-system imaging unit position will also be plane-projected. Performing the PnP positioning processing in this state as it is will make the calculation illogical or cause a significant error. To address these inconveniences, the calculation according to the present embodiment is performed after sorting out only the auxiliary markers 6 at the in-WC-system auxiliary marker known positions 62 that would be approximately within the imaging angle of view of an image captured from the in-WC-system imaging primary position determined by the primary positioning.

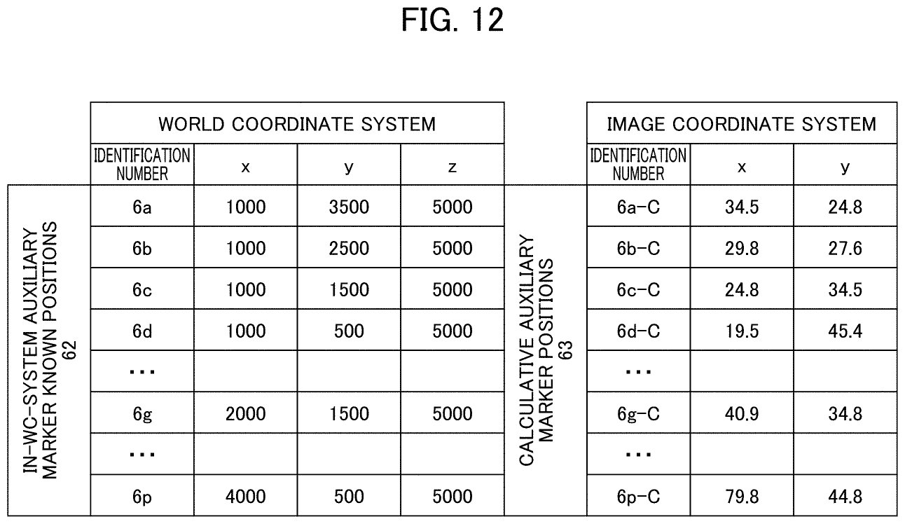

FIG. 12 shows the in-WC-system auxiliary marker known positions 62, which are known positions, and the calculative auxiliary marker positions 63, which are locations where the in-WC-system auxiliary marker known positions 62 would be drawn on the captured image 7. The calculative auxiliary marker position 63 calculated for the in-WC-system auxiliary marker known position 62 denoted by identification number 6a is denoted by identification number 6a-C.

The positioning finalization unit 107 performs linking processing (Step S109). As the linking processing, for example, the positioning finalization unit 107 associates the in-image auxiliary marker positions 61 with the calculative auxiliary marker positions 63, based on the positional relationship in one captured image, and then, links the auxiliary markers 6 to the in-WC-system auxiliary marker known positions 62 based on which the calculated auxiliary marker positions 63 are determined.

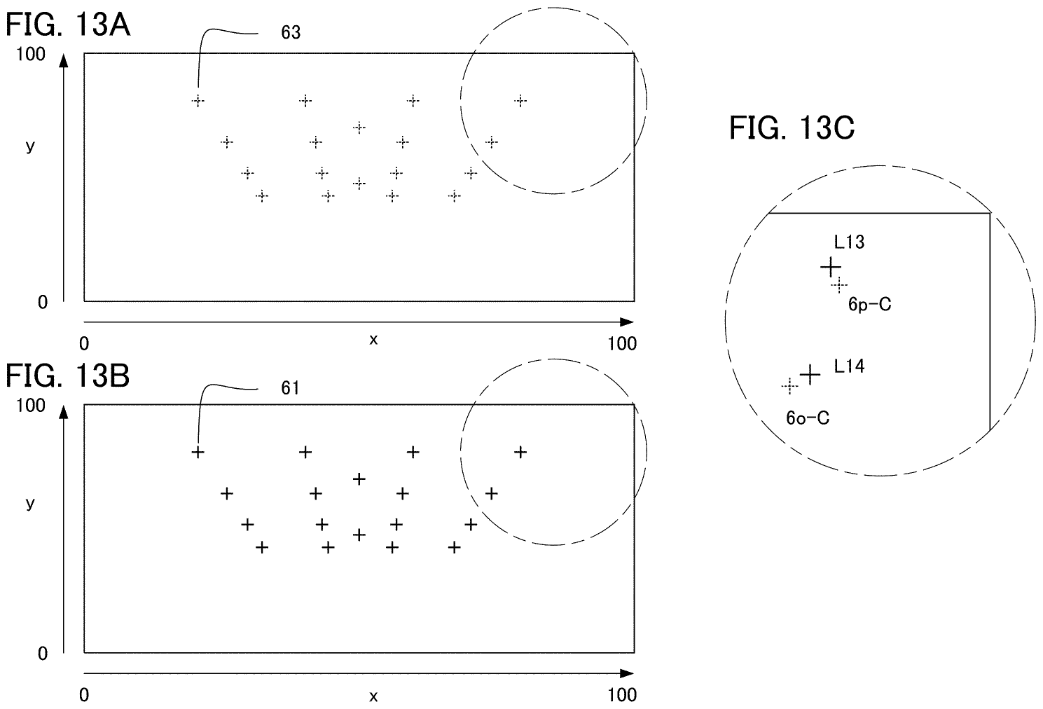

FIG. 13 illustrates a relationship between the calculative auxiliary marker positions 63 and the in-image auxiliary marker positions 61. As illustrated in FIG. 13A, not only the in-WC-system marker known positions 52, but also the calculative auxiliary marker positions 63 on the captured image 7 that correspond to the in-WC-system auxiliary marker known positions 62 are plotted on the image coordinate system 71. On the other hand, as illustrated in FIG. 13B, not only the in-image marker positions 51, but also the in-image auxiliary marker positions 61 corresponding to the auxiliary markers 6 are plotted on the image coordinate system 71. FIG. 13C illustrates, on an enlarged scale, an upper right portion of the image coordinate system 71 in a state in which FIGS.

13A and 13B are superimposed on each other. The calculative auxiliary marker positions 63 and the in-image auxiliary marker positions 61 are similar to each other but deviate from each other to some extent due to an error in the positioning. Among these points, ones that are closest to, or in proximity to, each other and that are in a positional relationship not disrupting the mutual positional relationship are linked to each other. In FIG. 13C, the calculative auxiliary marker position 63 denoted by identification number 6p-C and the in-image auxiliary marker position 61 denoted by identification number L13 are plotted in proximity to each other, and the calculative auxiliary marker position 63 denoted by identification number 6o-C and the in-image auxiliary marker position 61 denoted by identification number L14 are plotted in proximity to each other. These points are linked to or associated with each other as the mutually corresponding coordinate points.

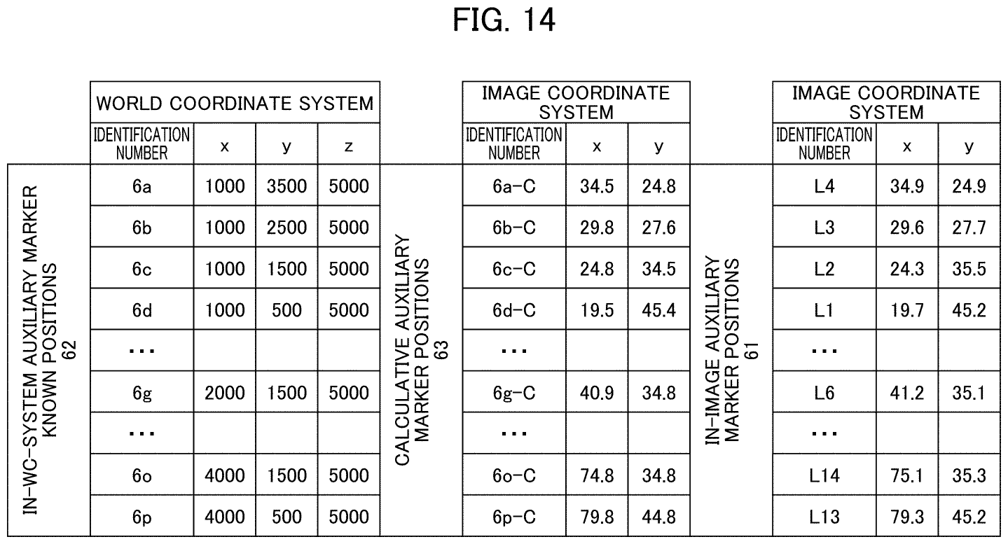

FIG. 14 shows a list of the calculative auxiliary marker positions 63 and the in-image auxiliary marker positions 61 linked to each other by the positioning finalization unit 107 in the manner described above. The in-WC-system auxiliary marker known positions 62, based on which the calculative auxiliary marker positions 63 have been calculated, are also shown in the list. The in-image auxiliary marker positions 61 are linked to the in-WC-system auxiliary marker known positions 62. At this stage, the auxiliary markers 6 that have been captured by the imaging unit 2 but not yet identified are identified as the auxiliary markers 6 whose positions are known. These identified auxiliary markers 6 serve similarly to the markers 5 because the auxiliary markers 6 are identified and their positions are known.

The primary positioning unit 104 calculates the in-WC-system imaging primary position of the imaging unit 2 based on the two markers 5. In this respect, the state in which the auxiliary markers 6 are linked to the in-WC-system auxiliary marker known positions 62 as shown in FIG. 14 has the same effect as an increase in the number of the markers 5 from two to eighteen including the sixteen identified auxiliary markers 6a to 6p.

The positioning finalization unit 107 further performs the PnP positioning processing (Step S110). For example, the positioning finalization unit 107 performs the PnP positioning processing, based on the in-WC-system marker known positions 52, the in-WC-system auxiliary marker known positions 62, the in-image marker positions 51, and the in-image auxiliary marker positions 61.

While the primary positioning has been performed according to the P2P positioning calculation, the processing in this step can be performed as a Pl8P problem in which positioning is performed based on the imaging results of the eighteen three-dimensional known points, whereby the accuracy is improved.

Then, the output unit 108 outputs the results of the PnP positioning processing as the determined positioning results.

The processing unit 100 performs positioning end determination processing (Step S112).

As the positioning end determination processing, the processing unit 100 ends the positioning process when positioning is to be ended (Step S112: YES). When the positioning is not to be ended (Step S112: NO), the processing unit 100 returns the positioning process to the stage denoted by “A” in the flowchart.

In the first embodiment, the P2P positioning processing is employed in the primary positioning, and two markers 5 are used as the minimum number of markers required for the primary positioning. The minimum number of the markers 5 may be set to six, i.e., P2P may be set as the minimum requirement for the positioning. This is because the position and imaging direction of the imaging unit 2 can be derived by way of the P2P positioning. Furthermore, the present embodiment is not limited to the above-described positioning based on two or six points, and is effective for all types of the PnP positioning processing.

### Effects of the Embodiment

In the first embodiment, as the primary positioning method, the markers 5 are specified and identified by the imaging unit 2, thereby eliminating the need to input an initial state, such as the position and imaging direction of the imaging unit 2 to the information processing apparatus 10, and the positioning of the imaging unit 2 can be determined at any point where the markers 5 can be captured in an image. The function of identifying the markers 5 is effective even in a case where the markers 5 are received as very small points formed on a captured image. Therefore, the positioning system 1 can be suitably constructed by additional installation of a minimum number of markers 5 for practically implementing the primary positioning. As a result, the positioning system 1 can be constructed at low cost and in a short period of time.

The information processing apparatus 10 includes the processing unit 100 that acquires, from images 7 captured by the imaging unit 2 that is provided to the movable body 3 and including the markers 5 and the auxiliary markers 6 that are disposed in a space, in-image marker positions 51 indicating the positions of the markers 5 in the image coordinate system 71 and in-image auxiliary marker positions 61 indicating the positions of the auxiliary markers 6 in the image coordinate system 71 by way of image processing, acquires the in-WC-system imaging primary position indicating a three-dimensional position of the imaging unit 2 in the world coordinate system 70, based on the in-image marker positions 51 and the in-WC-system marker known positions 52 indicating the known three-dimensional positions of the markers 5 in the world coordinate system 70, associates the in-image auxiliary marker positions 61 with the in-WC-system auxiliary marker known positions 62, based on the in-WC-system imaging primary position and the in-WC-system auxiliary marker known positions 62 indicating three-dimensional positions of the auxiliary markers 6 in the world coordinate system 70, and determines the position of the imaging unit 2 based on the in-image auxiliary marker positions 61 and the in-WC-system auxiliary marker known positions 62.

The provided information processing apparatus 10 functions with a smaller number of markers 5 and derives positioning results with high positioning accuracy.

The information processing apparatus 10 does not experience difficulty in highly accurately tracking, which can be caused in the case of using a radio wave. Further, unlike Visual-SLAM and LiDAR-SLAM, the information processing apparatus 10 does not cause a disadvantage that determination of positioning is less easily assured, and is free from a problem of loop closing. As a result, a practical positioning system can be constructed.

The processing unit 100 included in the information processing apparatus 10 identifies, from the captured images 7, identifiable light sources that emit visible light and are identifiable based on light emission modes thereof as the markers 5, and acquires the in-image marker positions 51.

Each marker 5 can be reliably identified based on its unique light emission mode captured in images.

The processing unit 100 included in the information processing apparatus 10 identifies two or more markers 5 from the captured images 7, acquires a plurality of in-image marker positions 51, and acquires the in-WC-system imaging primary position based on the plurality of in-image marker positions 51 and the in-WC-system marker known positions 52 respectively corresponding to the markers 5.

Even a small number of the markers 5 are sufficient for the processing unit 100 to acquire the in-WC-system imaging primary position. It is only necessary to provide a small number of the markers 5, thereby making it possible to reduce the cost, the number of man-hours to start up, and the like.

The processing unit 100 included in the information processing apparatus 10 specifies the imaging position and imaging direction for the captured images 7 based on the in-WC-system imaging primary position, calculates the calculative auxiliary marker positions 63 by performing projection calculation processing on an assumption that the in-WC-system auxiliary marker known positions 62 are projected onto the captured image 7, and associates the in-image auxiliary marker positions 61 with the in-WC-system auxiliary marker known positions 62 by associating the in-image auxiliary marker positions 61 with the calculative auxiliary marker positions 63.

The position of the auxiliary markers 6, from which the in-image auxiliary marker positions 61 originate, are identified as the in-WC-system auxiliary marker known positions 62. The auxiliary markers 6 become usable in the PnP positioning processing, just like the markers 5.

As a result of the projection calculation processing, the processing unit 100 included in the information processing apparatus 10 performs associating processing by associating one in-WC-system auxiliary marker known position 62, based on which the calculative auxiliary marker position 63 located at or in proximity to one in-image auxiliary marker position 61 is calculated, with the one in-image auxiliary marker position 61.

The associating processing is reliably performed by a simple process of acquiring the in-image auxiliary marker position 61 located in proximity to the calculative auxiliary marker position 63 in the image coordinate system 71.

A program causes a computer to perform functions that include: a function of acquiring positions of the markers 5 and the auxiliary markers 6 by acquiring, from images 7 captured by the imaging unit 2 that is provided to the movable body 3 and including the markers 5 and the auxiliary markers 6 that are disposed in a space, the in-image marker positions 51 indicating the positions of the markers 5 in the image coordinate system 71 and the in-image auxiliary marker positions 61 indicating the positions of the auxiliary markers 6 in the image coordinate system 71 by way of image processing; a primary positioning function of acquiring the in-WC-system imaging primary position indicating a three-dimensional position of the imaging unit 2 in the world coordinate system 70, based on the in-image marker positions 51 and the in-WC-system marker known positions 52 indicating known three-dimensional positions of the markers 5 in the world coordinate system 70; and a positioning determination function of associating the in-image auxiliary marker positions 61 with the in-WC-system auxiliary marker known positions 62, based on the in-WC-system imaging primary position and the in-WC-system auxiliary marker known positions 62 indicating three-dimensional positions of the auxiliary markers 6 in the world coordinate system 70, and determining the position of the imaging unit 2 based on the in-image auxiliary marker positions 61 and the in-WC-system auxiliary marker known positions 62.

The provided program functions with a small number of markers 5 and derives positioning results with high positioning accuracy.

A positioning method performable by a computer includes: acquiring positions of the markers 5 and the auxiliary markers 6 by acquiring, from images 7 captured by the imaging unit 2 that is provided to the movable body 3 and including the markers 5 and the auxiliary markers 6 that are disposed in a space, in-image marker positions 51 indicating the positions of the markers 5 in the image coordinate system 71 and in-image auxiliary marker positions 61 indicating the positions of the auxiliary markers 6 in the image coordinate system 71 by way of image processing; performing primary positioning by acquiring the in-WC-system imaging primary position indicating the three-dimensional position of the imaging unit 2 in the world coordinate system 70, based on the in-image marker positions 51 and the in-WC-system marker known positions 52 indicating the known three-dimensional positions of the markers 5 in the world coordinate system 70; and determining positioning by associating the in-image auxiliary marker positions 61 with the in-WC-system auxiliary marker known positions 62, based on the in-WC-system imaging primary position and the in-WC-system auxiliary marker known positions 62 indicating the three-dimensional positions of the auxiliary markers 6 in the world coordinate system 70, and definitively determining the position of the imaging unit 2 based on the in-image auxiliary marker positions 61 and the in-WC-system auxiliary marker known positions 62.

The provided method functions with a small number of markers 5 and derives positioning results with high positioning accuracy.

Next, embodiments different from the first embodiment will be described. In the following description, components that are the same or similar to those described in the first embodiment are denoted by the same reference numerals, and description thereof may be omitted.

### Second Embodiment

In the first embodiment, an example in which the position of the circular auxiliary marker 6 is set based on the center of the region of the auxiliary marker 6 has been described. In the second embodiment described below, the position of the auxiliary marker 6 is specified by a different method.

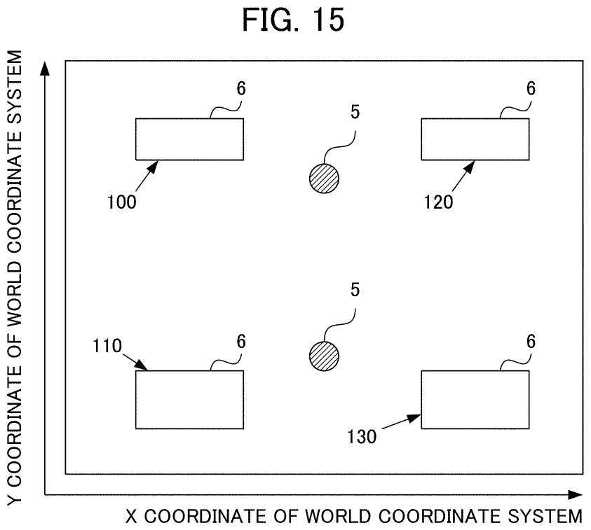

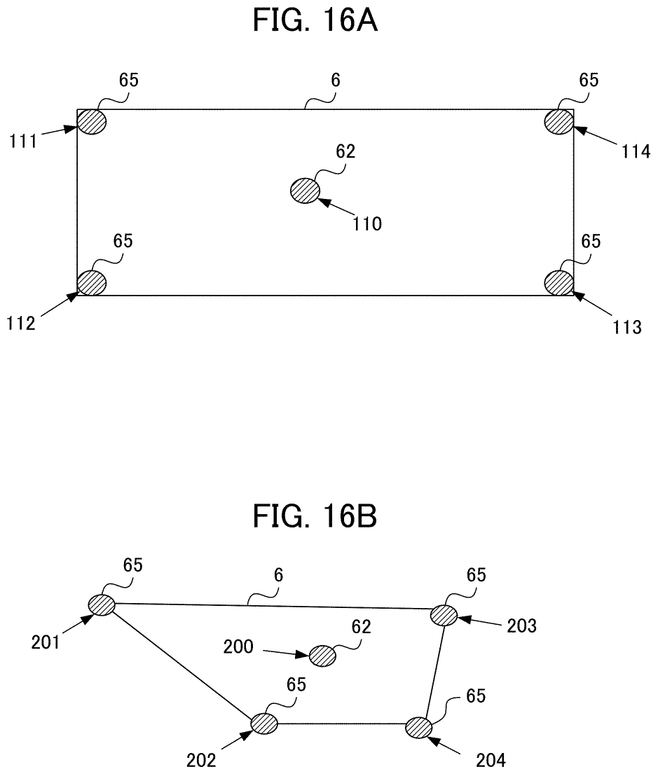

FIG. 15 is a schematic diagram illustrating an example in which the auxiliary markers 6 according to the second embodiment have a quadrangular shape. The auxiliary markers 6 are assigned with identification numbers 100, 110, 120, and 130, respectively. In the figure, arrows indicate correspondence between the auxiliary markers 6 and the identification numbers. The same applies hereinafter. FIG. 16 is a schematic diagram illustrating an example in which auxiliary marker positions are assigned to the vertexes of the quadrangular auxiliary marker 6 according to the second embodiment. As shown in FIG. 15, a lighting device having a rectangular shape in plan view is also usable as the auxiliary marker 6. In the second embodiment, as illustrated in FIG. 16A, processing is performed to assign vertex reference numerals 111 to 114 to in-WC-system outline known positions 65 as in-WC-system auxiliary marker known positions 62. In FIG. 16A, arrows indicate correspondence between parts and the reference numerals. The same applies hereinafter. Thus, in the case of the quadrangular auxiliary marker 6, the in-WC-system auxiliary marker known positions 62 at five locations in total, namely, the center and the four corners of the auxiliary marker 6 can be acquired as three-dimensional positions in the world coordinate system 70. In the following description, the position of each vertex is referred to as the in-WC-system outline known position 65. The position of the auxiliary marker 6 in the image coordinate system 71 on the captured image 7 is referred to as the in-image outline position 64.

FIG. 16B illustrates an auxiliary marker 6 having a polygonal shape other than a rectangular shape, such as a trapezoid shape. The in-WC-system outline known positions 65 can be assigned also to the vertexes of this auxiliary marker 6 as in-WC-system auxiliary marker known positions 62. As illustrated in FIG. 16B, for example, the center of the auxiliary marker 6 is assigned with a known marker position 62 in the world coordinate system 70 (hereinafter referred to as the in-WC-system auxiliary marker known positions 62), and the vertexes of the auxiliary marker 6 are assigned with the in-WC-system outline known positions 65, which are denoted by identification numbers 200 to 204, respectively. While the examples illustrated in FIGS. 16A and 16B both have a quadrangular shape, the shape is not limited thereto. For example, even in the case of a triangle, a pentagon, or a polygon with more vertexes, each vertex can be added as the in-WC-system outline known position 65, and the in-image outline position 64 of each vertex can be acquired, so that the secondary positioning can be performed.

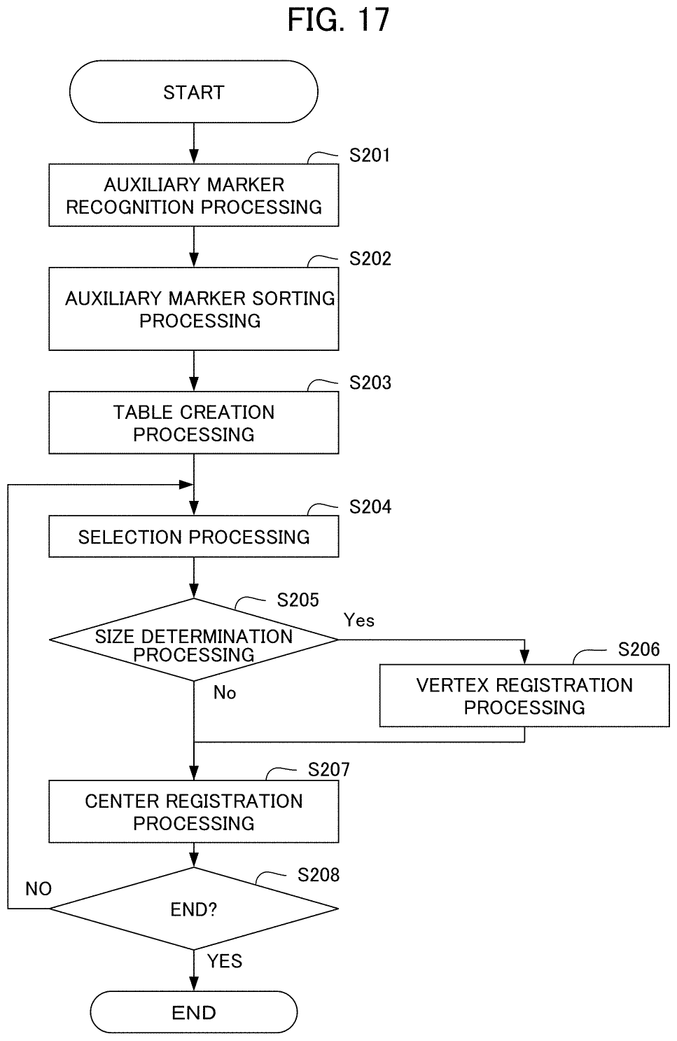

Processing for Extracting In-WC-System Auxiliary Marker Known Positions FIG. 17 is a flowchart illustrating a flow of processing performable in a case where the auxiliary marker 6 according to the second embodiment has a polygonal shape. The processing unit 100 performs the processing to extract the in-WC-system auxiliary marker known positions 62 and the in-WC-system outline known positions 65.

Upon a start of creation of a table of the in-image auxiliary marker positions 61, the image processing unit 101 first performs auxiliary marker recognition processing (Step S201). As the auxiliary marker recognition processing, for example, the image processing unit 101 extracts regions with saturated luminance from a captured image 7, and assigns primary identification numbers to the extracted regions.

Further, the image processing unit 101 performs auxiliary marker sorting processing (Step S202). As the auxiliary marker sorting processing, for example, the image processing unit 101 performs sorting based on the shapes of the extracted regions. The image processing unit 101 sorts out, for example, an elliptic shape and a quadrangular shape, and excludes shapes overlapping with the edge of the image.

Subsequently, the image processing unit 101 performs table creation processing (Step S203). As the table creation processing, for example, the image processing unit 101 registers the extracted candidate regions in a primary table.

The auxiliary marker identification unit 106 performs selection processing (Step S204). As the selection processing, for example, the auxiliary marker identification unit 106 selects one of the regions.

The auxiliary marker identification unit 106 performs size determination processing. As the size determination processing, for example, the auxiliary marker identification unit 106 determines whether or not the size of the auxiliary marker 6 in the captured image 7 is equal to or larger than a predetermined size. The predetermined size is, for example, a size of 7×7 in terms of pixels of the captured image 7.

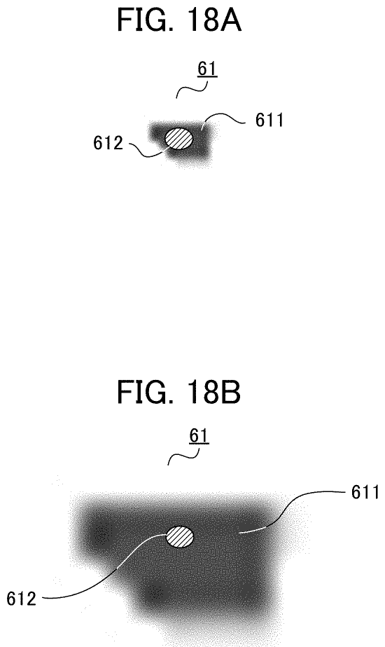

The size determination processing will be described with reference to FIG. 18. For example, in a case where a small image is formed due to imaging at a long distance, using points at the four corners in the image may make it more likely for an error to occur. Therefore, in the size determination process, in order to avoid performing determination that is highly likely to cause an error, it is determined whether or not the region as a candidate for the auxiliary marker 6 is of a size equal to or larger than the predetermined size.

When the extracted region has a size equal to or larger than the predetermined size (Step S205: YES), the auxiliary marker identification unit 106 performs vertex registration processing (Step S206). As the vertex registration processing, for example, the auxiliary marker identification unit 106 registers the four vertexes of the auxiliary marker 6 having a quadrangular shape, as the in-image outline positions 64. As shown in FIG. 18A, in a case where there is one candidate for the auxiliary markers 6 based on which an in-image auxiliary marker position 61 can be acquired, it is possible to use only a partial region 612 at the center of a region 611 corresponding to the candidate. There is also a case where a candidate appears as a polygon as shown in FIG. 18B, but the boundary is blurred and the vertexes are not clear. Also in this case, a partial region 612 at the center of the region 611 corresponding to the candidate may be used.

Subsequently, the auxiliary marker identification unit 106 performs center registration processing (Step S207). As the center registration process, for example, the auxiliary marker identification unit 106 registers the center of the extracted region as the in-image auxiliary marker position 61, regardless of the size of the extracted region.

The processing unit 100 performs process end determination processing (Step S208).

When the process is not to be ended (Step S208: NO), the processing unit 100 returns the positioning process to Step S204. When the process is to be ended (Step S208: YES), the processing unit 100 ends the creation of the list of the in-image auxiliary marker positions 61.

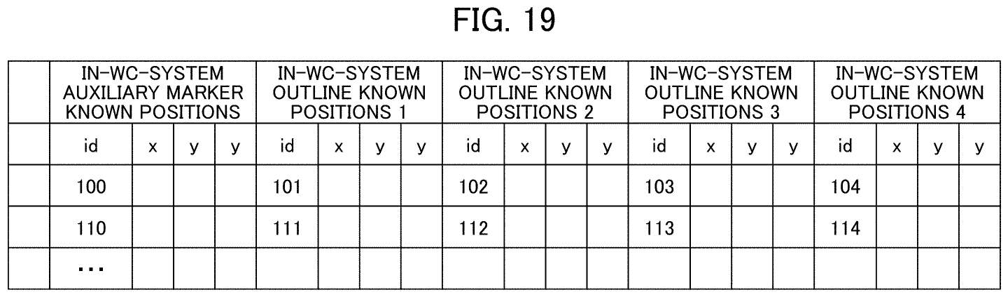

FIG. 19 illustrates an example in which the in-WC-system outline known positions 65 corresponding to the vertexes of the polygonal auxiliary markers 6 described above are identified and registered in associations with the in-WC-system auxiliary marker known positions 62. The number of tens and the number of hundreds are adopted for the center position, and the number of units is adopted for the in-WC-system outline known position 65 corresponding to the vertex.

In the present embodiment, lighting devices or light sources installed in the environment are used as the auxiliary markers 6, which can be used as a complement in a case where a small number of markers 5 are installed. When indoor lighting devices as the auxiliary markers 6 are normally captured in an image, luminance appears as a saturated region in the image. Therefore, to perform the first extraction of candidates for the auxiliary marker regions, it is only necessary to carry out simple binarizing processing using a saturation value, thereby obtaining highly stable image signals. In addition, lighting devices are generally disposed in a space with good visibility, and many of the lighting devices have a simple shape such as a round shape or a square shape, and can be suitably used as the auxiliary markers 6 of the present embodiment. The auxiliary marker 6 is not limited to such a lighting device, and may be any other device or object as long as it can be detected stably by a simple method in a scene of use. For example, it is conceivable to employ a high-chroma object or the like disposed in a low-chroma environment with good visibility because binarizing processing can be performed with a specific high-chroma threshold value.

As described above, in the second embodiment, the auxiliary marker 6 having a polygonal shape is used, and an increased number of the in-WC-system outline known positions 65 are obtained as a form of the in-WC-system auxiliary marker known position 62. This feature makes it possible to provide a plurality of in-WC-system auxiliary marker known positions 62 by means of one auxiliary marker or lighting device.

The processing unit 100 included in the information processing apparatus 10 acquires the in-image auxiliary marker positions 61 of the auxiliary marker 6 based on the positions of the vertexes of the polygonal shape of the auxiliary marker 6 in the captured image 7.

This feature makes it possible to increase the number of the in-WC-system auxiliary marker known positions 62 without increasing the number of auxiliary markers 6, thereby improving the accuracy of the PnP positioning processing.

In a case where the auxiliary marker 6 in the captured image 7 is of a size smaller than the predetermined size, the processing unit 100 included in the information processing apparatus 10 acquires the center position of the auxiliary marker 6 and acquires the in-image auxiliary marker position 61 based on the center position.

Consequently, the in-WC-system auxiliary marker known position 62 for use in the PnP positioning processing is optimized, thereby achieving higher positioning accuracy.

### (Modifications of Marker)

In the positioning process described above, the markers 5 adapted to be identified are used in one primary positioning method. The primary positioning may be performed by other means. Examples of such means will be briefly described below.

In a case where the positioning determination unit 107 has been just completed the PnP positioning processing, the current position can be estimated from a difference based on a past position and a latest vector, and the current position can be defined as the in-WC-system imaging primary position. Nevertheless, this process is not available in an initial state.

An image of a two-dimensional code is captured by the imaging unit 2, and primary setting of the position of the imaging unit 2 can be performed based on the code and the imaging angle of the imaging unit 2. For the positioning performed by recognizing such a two-dimensional code or the like, it is preferable to display the two-dimensional code in a relatively large area on an imaging screen.

For example, an infrared sensor may be provided as a specific point, and primary setting of the position of the imaging unit 2 can be performed based on detection of passage through the specific point. In a case where the imaging unit 2 is mounted to the movable body 3, and it is guaranteed that the starting point of the movable body 3 is the specific point, primary setting of the position of the imaging unit 2 can be performed based on the position of the specific point. The information regarding the specific point may be stored as imaging unit installation parameters 24 in the database 19 illustrated in FIG. 4. For example, in a case where the movable body 3 starts from a charge station, if the identification number of the charge station is known, primary setting of the position of the imaging unit 2 can be performed. For example, the elevation angle, the focal length, the presence or absence of the autofocus function of the imaging unit 2 may be stored as the imaging unit internal parameters 23 in the database 19 illustrated in FIG. 4. Two or more of the various means described above may be combined with each other. However, the method of using the marker 5, which is adapted to be identified, in particular, based on the color change signal of the light emitter, is suitable for performing the primary positioning with relatively high accuracy in a large area.

As described above, the present invention is not limited to a marker that performs optical communication by changing the light emission modes as in the case of the markers 5 of the above embodiment, and other types of markers 5 can be used as described in the modifications.

Next, an example of processing performable after the in-WC-system auxiliary marker known positions 62 are identified in the captured image 7 will be described.

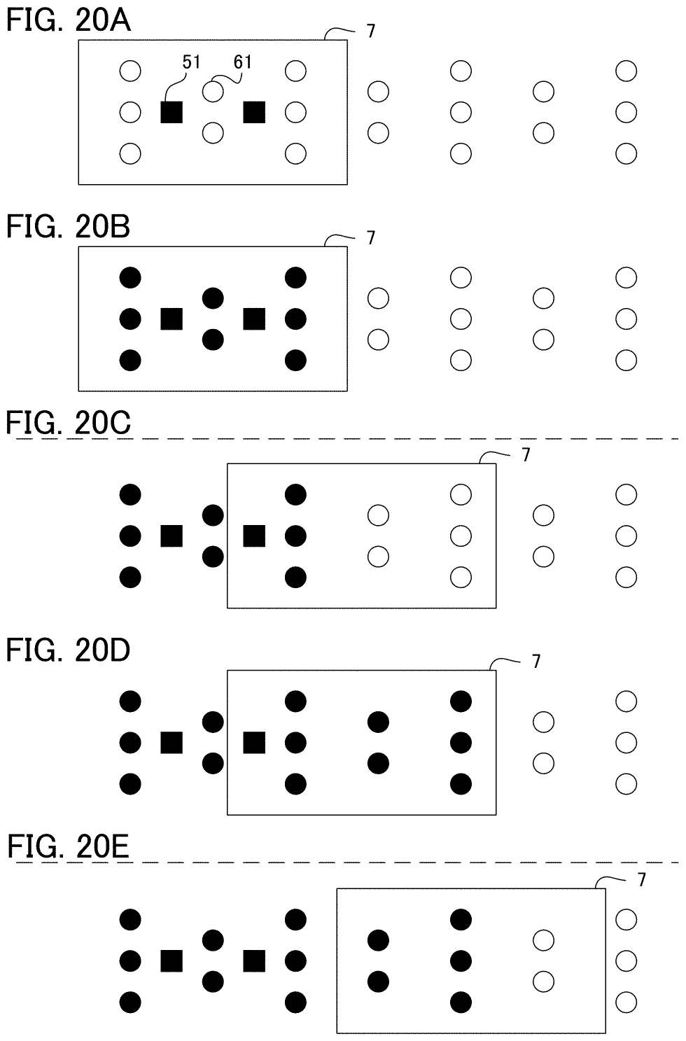

FIG. 20 more specifically illustrates positioning processing that is performed using the ceiling 4 on which the markers 5 and the auxiliary markers 6 are disposed. The auxiliary markers 6 have been identified, like the markers 5. In the following description, the primary positioning unit 104 uses the in-WC-system auxiliary marker known positions 62 for the primary positioning, like the markers 5.

For the sake of convenience, FIG. 20 is based on an assumption that the markers 5 and the auxiliary markers 6 are arranged in an orderly manner, and the imaging unit 2 is provided orthogonally to these markers. In the figure, the quadrangular region indicates an imaging range corresponding to the captured image 7. FIG. 20A illustrates an initial state. The markers 5 are captured in the image and the in-image marker positions 51 are recognized. The in-image auxiliary marker positions 61 are acquired. The markers 5 are indicated by black filled-in squares in FIG. 20A, which means they have been identified.

In a similar manner as described in the first embodiment, the in-WC-system imaging primary position of the imaging unit 2 is calculated based on the in-image marker positions 51 and the in-WC-system marker known positions 52. Then, the calculative auxiliary marker positions 63 are calculated on the assumption that the auxiliary markers 6 located at the in-WC-system auxiliary marker known positions 62 are captured in an image from the in-WC-system imaging primary position. In other words, projection calculation processing is performed. Thereafter, for example, by associating the neighboring points, the auxiliary markers 6 from which the in-image auxiliary marker positions 61 originate are linked to the in-WC-system auxiliary marker known positions 62 on which the calculation is based. Thus, the auxiliary markers 6 shown in the captured image 7 are recognized as identified auxiliary markers 6 whose positions are known. Here, the auxiliary markers 6 serve as identifiable indicators, similarly to the markers 5. To describe this situation, the auxiliary markers 6 indicated by hollow circles in FIG. 20A are now indicated by black filled-in circles in FIG. 20B.

When the movable body 3 continuously moves from this state, the images 7 captured by the imaging unit 2 change as illustrated in FIG. 20C. Here, image processing is performed to maintain the link between the in-image auxiliary marker positions 61 in the captured image 7 and the in-WC-system auxiliary marker known positions 62. In FIG. 20C, the in-image marker position 51 and the in-image auxiliary marker positions 61 are maintained for the marker 5 and the auxiliary markers 6 indicated by the respective filled-in figures, which means that the markers are identified. Since the four black filled-in figures in the captured image 7 shown in FIG. 20C have been identified, they can be used for the primary positioning of the imaging unit 2, similarly to the in-image marker positions 51 shown in FIG. 20A. A comparison with calculative auxiliary marker positions 63 is then made, so that the in-image auxiliary marker positions 61 in the captured image 7 in FIG. 20C are newly linked to the in-WC-system auxiliary marker known positions 62, and come to serve as identifiable indicators, similarly to the markers 5. To describe this state, the auxiliary markers 6 indicated by hollow circles in FIG. 20C are now indicated by black filled-in circles in FIG. 20D.

The process described above is repeated. FIG. 20E illustrates an image 7 captured when the movable body 3 has further moved from the state corresponding to FIG. 20C. At this point in time, the in-image marker positions 51 originating from the markers 5 are not included in the captured image 7. The primary positioning unit 104 performs primary positioning of the imaging unit 2 based on the identified auxiliary markers 6, and the positioning finalization unit 107 determines the positioning of the imaging unit 2.

Thus, the above-described configuration, in which the positions of the auxiliary markers 6 are continuously measured and identified subsequent to the identification of the markers 5 disposed only in the vicinity of the initial position of movement, makes it practical to install the markers 5 in the initial position even in a large area. That is, subsequent to the processing based on the markers 5, even if the markers 5 are not included in the captured images 7, the auxiliary markers 6 included in the captured images 7 allow for deriving the in-WC-system imaging unit determined position of the imaging unit 2.

In the foregoing, the positioning process based on the markers 5 has been described. It should be noted that the embodiments and modifications described above are not intended to limit the present invention, and the present invention encompasses improvements and the like within the range where the object of the present invention can be achieved.

Further, in the above embodiments, the information processing apparatus 10 to which the present invention is applied has been described by referring to the forklift as an example of the movable body 3, but the present invention is not limited thereto. For example, the present invention can be applied to general electronic apparatuses having an image processing function. Specifically, the present invention can be applied to, for example, a notebook personal computer, a portable navigation device, a mobile phone, a smartphone, and a portable game console.

The processing sequence described above can be executed by hardware, and can also be executed by software. In other words, the functional configuration of FIG. 4 is merely an illustrative example, and the present invention is not particularly limited thereto. More specifically, the types of functional blocks employed to realize the above-described functions are not particularly limited to the examples shown in FIG. 4, so long as the information processing apparatus 10 can be provided with the functions enabling the aforementioned processing sequence to be executed in its entirety.

In addition, a single functional block may be configured by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like. The computer may be a computer equipped with dedicated hardware. In addition, the computer may be a computer capable of executing various functions, e.g., a general purpose personal computer, by installing various programs.

The storage medium containing such a program can not only be distributed separately from an apparatus main body to supply the program to a user, but also can be constituted by a storage medium or the like supplied to the user in a state incorporated in the apparatus main body in advance. The removable medium is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) disc or the like. The magnetic optical disk is composed of an MD (Mini-Disk) or the like. The storage medium supplied to the user in a state incorporated in the apparatus main body in advance is constituted by, for example, the ROM 12 in which the program is recorded or a hard disk (not shown).

It should be noted that, in the present specification, the steps defining the program recorded in the storage medium include not only the processing executed in a time series following this order, but also processing executed in parallel or individually, which is not necessarily executed in a time series. Further, in the present specification, the terminology of the system means an entire apparatus including a plurality of apparatuses and a plurality of units.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An information processing apparatus comprising:
one or more processors configured to:
acquire from an image captured by an imaging unit and including a marker disposed in a space, a position of the marker in an image coordinate system,
acquire primary positioning information regarding the imaging unit in a world coordinate system, based on the position of the marker in the image coordinate system and a position of the marker in the world coordinate system,
determine positioning information regarding the imaging unit, based on the primary positioning information regarding the imaging unit in the world coordinate system and the position of the marker in the world coordinate system.

2. The information processing apparatus according to claim 1,
wherein the image further includes an auxiliary marker in addition to the marker, and
wherein the one or more processors:
acquire the position of the marker in the image coordinate system and a position of the auxiliary marker in the image coordinate system,
associate, based on the primary positioning information regarding the imaging unit and a position of the auxiliary marker in the world coordinate system, the position of the auxiliary marker in the image coordinate system with the position of the auxiliary marker in the world coordinate system, and
determine the primary positioning information regarding the imaging unit, based on the position of the auxiliary marker in the image coordinate system and the position of the auxiliary marker in the world coordinate system associated with each other.

3. The information processing apparatus according to claim 1,
wherein the one or more processors:
identify, from the image captured, a light source that is identifiable based on a light emitting mode thereof as the marker, and
acquires the position of the marker in the image coordinate system.

4. The information processing apparatus according to claim 1,
wherein the one or more processors:
identify the marker comprising two or more markers from the image captured,
acquire a plurality of positions of markers in the image coordinate system,
acquire the primary positioning information regarding the imaging unit, based on the plurality of positions of markers in the image coordinate system and positions in the world coordinate system that respectively correspond to the two or more markers identified.

5. The information processing apparatus according to claim 2,
wherein the one or more processors:
specify an imaging position and an imaging direction for the image captured, based on the primary positioning information,
calculate a new position of the auxiliary marker by performing projection calculation processing on an assumption that the position of the auxiliary marker in the world coordinate system is projected onto the image captured, and
associate the position of the auxiliary marker in the world coordinate system with the calculated new position of the auxiliary marker so as to associate the position of the auxiliary marker in the image coordinate system with the position of the auxiliary marker in the world coordinate system.

6. The information processing apparatus according to claim 2,
wherein the auxiliary marker has a polygonal shape, and
wherein the one or more processors:
acquire the position of the auxiliary marker in the image coordinate system, based on positions of vertexes of the polygonal shape of the auxiliary marker in the image captured.

7. The information processing apparatus according to claim 6,
wherein the one or more processors:
acquire a center position of the auxiliary marker in a case where the auxiliary marker in the image captured is of a size smaller than a predetermined size, and
acquire the position of the auxiliary marker in the image coordinate system, based on the center position.

8. A non-transitory computer-readable storage medium storing a program that causes a computer to perform operations comprising:
acquiring, from an image captured by an imaging unit and including a marker disposed in a space, a position of the marker in an image coordinate system,
acquiring primary positioning information regarding the imaging unit in a world coordinate system, based on the position of the marker in the image coordinate system and a position of the marker in the world coordinate system, and
determine positioning information regarding the imaging unit, based on the primary information regarding the imaging unit in the world coordinate system and the position of the marker in the world coordinate system.

9. A positioning method executable by a computer, the positioning method comprising:
acquiring, from an image captured by an imaging unit and including a marker disposed in a space, a position of the marker in an image coordinate system,
acquiring primary positioning information regarding the imaging unit in a world coordinate system, based on the position of the marker in the image coordinate system and a position of the marker in the world coordinate system, and
determining positioning information regarding the imaging unit, based on the primary information regarding the imaging unit in the world coordinate system and the position of the marker in the world coordinate system.
